(19) United States
(12) Patent Application Publication
(10) Pub. No.: US 2011/0252463 A1
(43) Pub. Date: Oct. 13, 2011

(54) METHOD AND SYSTEM FOR PROVIDING ENTERPRISE PROCUREMENT NETWORK

(75) Inventors: Chandra Yeleshwarapu, Foster City, CA (US); Keshava Rangarajan, Foster City, CA (US); Sudeep Agarwal, San Francisco, CA (US); Athanasios Bismpigiannis, Sunnyvale, CA (US); Nagaraj Srinivasan, Union City, CA (US)

(73) Assignee: Oracle International Corporation, Redwood Shores, CA (US)

(21) Appl. No.: 12/757,763

(22) Filed: Apr. 9, 2010

(51) Int. Cl. G06F 3/01; H04L 9/32; G06F 21/00; G06F 17/30

(52) U.S. Cl. 726/7; 707/769; 707/723; 715/753; 707/802; 707/E17.014; 707/E17.044; 707/E17.005

(57) ABSTRACT

According to an embodiment, the present invention provides a computer system. The computer system includes one or more processors and a computer-readable medium in communication with the one or more processors. The computer system also includes an enterprise social network system, implemented by an enterprise application stored on the computer-readable storage medium, for retrieving and providing procurement information from a plurality of social network entities associated with the enterprise social network system, the enterprise social network system comprising a set of instructions executable by the one or more processors to perform one or more operations. The set of instructions includes instructions for providing, at a computer system, a user interface for receiving input from a user. The set of instructions includes instructions for providing a user profile for a user, the user profile being stored at the enterprise social network system, the user being associated with a plurality of network entities, the user profile including a first plurality of user attributes.

### CROSS-REFERENCES TO RELATED APPLICATIONS

This application relates to U.S. patent application Ser. No. ______, Attorney Docket No. 021756-097800US, entitled PRODUCT CLASSIFICATION IN PROCUREMENT SYSTEMS, filed on ______, U.S. patent application Ser. No. ______, Attorney Docket No. 021756-097900US, entitled METHOD AND SYSTEM FOR PROVIDING DECISION MAKING BASED ON SENSE AND RESPOND, filed on ______, U.S. patent application Ser. No. ______, Attorney Docket No. 021756-098400US, entitled COMMUNITY RATING IN ENTERPRISE APPLICATIONS, filed on ______, which are incorporated by reference in their entirety for any and all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention is directed to a method and system for providing enterprise procurement network. More specifically, various embodiments of the present invention provide techniques for providing a procurement system in which users are able to access a plurality of social network entities, both inside and outside an enterprise network.

Over the last few decades, with the advent of computer technologies, social network applications have become popular tools for people to connect and communicate to one another. For example, social network websites, blogs, forums, and other types of network entities are now popular platforms for people to interact with one another. An increasing number of business organizations have implemented internal social networks (e.g., internal FAQ database, forums, etc.) to help employees work efficiently. Unfortunately, conventional techniques and systems are often inadequate, especially for enterprise procurement type of applications.

Therefore, improved systems and methods for providing enterprise procurement network are greatly desired.

### BRIEF SUMMARY OF THE INVENTION

The present invention is directed to a method and system for providing enterprise procurement network. More specifically, various embodiments of the present invention provide techniques for providing a procurement system in which users are able to access a plurality of social network entities, both inside and outside an enterprise network. For example, using the procurement system, users are able to search for products and services from the plurality of social network entities. In various embodiments, the procurement systems according to the present invention are configured to provide security and access policies based on the types of network entities (e.g., enterprise network are deemed more secure and/or reliable than outside social networks). There are other embodiments as well, as will be described below.

According to an embodiment, the present invention provides a computer system. The computer system includes one or more processors and a computer-readable medium in communication with the one or more processors. The computer system also includes an enterprise social network system, implemented by an enterprise application stored on the computer-readable storage medium, for retrieving and providing procurement information from a plurality of social network entities associated with enterprise social network system, the enterprise social network system comprising a set of instructions executable by the one or more processors to perform one or more operations. The set of instructions includes instructions for providing, at a computer system, a user interface for receiving input from a user. The set of instructions includes instructions for providing a user profile for a user, the user profile being stored at the enterprise social network system, the user being associated with a plurality of network entities, the user profile including a first plurality of user attributes, and the network entities including enterprise entities and social network entities. The set of instructions includes instructions for retrieving entities attributes from each of the network entities. The set of instructions includes instructions for processing entities attributes. The set of instructions includes instructions for determining entity types for network entities. The set of instructions includes instructions for providing a first access setting for the enterprise entities, the first access setting being associated with a first security level. The set of instructions includes instructions for providing a second access setting for the social network entities, the second access setting being associated with a second security level. The set of instructions includes instructions for receiving, at the user interface, one or more queries for procurement. The set of instructions includes instructions for processing the one or more queries. The set of instructions includes instructions for generating a search setting related to the one or more queries, the search settings being based at least on the user attributes, entity attributes, and the one or more queries. The set of instructions includes instructions for accessing the network entities in accordance to the search settings. The set of instructions includes instructions for generating a first set of query results from the enterprise entities. The set of instructions includes instructions for generating a second set of query results from the social network entities. The set of instructions includes instructions for generating a search report, the search report including information from the first set of query results and the second set of query results. The set of instructions includes instructions for displaying, at the user interface, the search report.

Further embodiments of the present invention describe a write-back to ontology. Various user actions from within the application are recorded back into the ontology. This may enrich the ontology by keeping it current and relevant. FIG. 1 illustrates this in an overall architecture block diagram 100. For example, if a product is reviewed by a user, the review entity in the ontology is updated. Similarly the user entity is updated for the user who wrote the review. This in turn affects the user's credibility in the system (as discussed in U.S. patent application Ser. No. ______, Attorney Docket No. 021756-098400US, entitled COMMUNITY RATING IN ENTERPRISE APPLICATIONS, filed on ______). Similarly when a user orders an item through the procurement system, all related entities, Product, User, Supplier and Invoice, are updated in the ontology (referring to the ontology in FIGS. 6A and 6B, described below).

Refreshing the ontology (as in FIGS. 6A and 6B) keeps the system current and relevant. This may impact search results, as well as ratings of various entities in the system. For example, a frequently reviewed item appears higher in search results since it is more relevant. Similarly, products purchased often by others within the user's network may be more relevant and therefore may appear higher in the user's search results. Ratings may be calculated based on the ontology (as discussed in U.S. patent application Ser. No. ______, Attorney Docket No. 021756-098400US, entitled COMMUNITY RATING IN ENTERPRISE APPLICATIONS, filed on ______) and refreshing the ontology keeps ratings up to date. For example, a supplier may be rated higher if the product supplied by the supplier gains popularity among users. Based on the supplier's rating, the system recommends that supplier to the buyer, when the buyer desires to invite suppliers to a sourcing event.

System 100 includes data sources 101 in communication with ESB 102 and Hadoop Distributed Data Processing 103. System 100 further includes Search Information Indexing Services 104, ERP (such as Oracle's E-Business Suite), ETL, and Analysis Platform 105, and In-memory Processing Platform 106. The In-memory Processing Platform 106 is in communication with SOA Platform 107, which is in communication with Ontology Query Services 108. Furthermore, system 100 includes a Visualization Platform 109 in communication with the Ontology Query Platform 108 and a Fed. Search Engine 110. It should be noted that System 100 is not intended to limit the scope of this application, but instead is merely an example of platforms which may be used to implement aspects of the present invention.

According to another embodiment, the present invention provides an apparatus. The apparatus includes a computer-readable medium having encoded thereon a set of instructions executable by one or more computers to provide a procurement system. The set of instructions includes instructions for providing a user interface for receiving input from a user. The set of instructions includes instructions for receiving, at the user interface, inputs for logging on to a user profile. The set of instructions includes instructions for accessing the user profile, the user profile being stored at an enterprise network system, the user profile including a plurality of attributes, the plurality of attributes including association between the user and network entities, the network entities including enterprise entities and external entities, the network entities including a first plurality of contacts. The set of instructions includes instructions for receiving a user request for adding a first network entity to the user profile, the first network entity being associated with one or more procurement projects. The set of instructions includes instructions for processing the user request. The set of instructions includes instructions for determining a network type for the first network entity. The set of instructions includes instructions for generating a first access policy for the first network entity. The set of instructions includes instructions for retrieving information from the first network entity, the information associated with a second plurality of contacts stored at the first network entity. The set of instructions includes instructions for processing the information associated with the second plurality of contacts. The set of instructions includes instructions for displaying first and second pluralities of contacts at the user interface.

According to yet another embodiment, the present invention provides a method for providing a procurement system. The method includes providing, at a computer system, a user interface for receiving input from a user. The method includes providing a user profile for a user, the user profile being stored at the enterprise social network system, the user being associated with a plurality of network entities, the user profile including a first plurality of user attributes, the network entities including enterprise entities and social network entities. The method includes retrieving entity attributes from each of the network entities. The method includes processing entity attributes. The method includes providing a first access setting for the enterprise entities, the first access setting being associated with a first security level. The method includes providing a second access setting for the social network entities, the second access setting being associated with a second security level. The method includes receiving, at the user interface, one or more queries for procurement. The method includes processing the one or more queries. The method includes generating a search setting related to the one or more queries, the search settings being based at least on the user attributes, entity attributes, and the one or more queries. The method includes searching the network entities in accordance to the search settings. The method includes retrieving a first set of query results from the enterprise entities. The method includes retrieving a second set of query results from the social network entities. The method includes filtering the first and second sets of query results based at least on the user profile. The method includes generating a search report, the search report including information from the first set of query results and the second set of query results. The method includes displaying, at the user interface, the search report.

Various additional objects, features and advantages of the present invention can be more fully appreciated with reference to the detailed description and accompanying drawings that follow.

### BRIEF DESCRIPTION OF THE DRAWINGS

FIG. 1 is a simplified block diagram illustrating overall architecture according to an embodiment of the present invention.

FIG. 2 is a simplified block diagram illustrating a hybrid social network according to an embodiment of the present invention.

FIG. 3 is a simplified flow diagram illustrating a method that can be used to assist a user in customizing a network community according to an embodiment of the present invention.

FIG. 4A is a simplified diagram illustrating a graphical user interface for receiving user inputs for customizing a custom community network according to an embodiment of the present invention.

FIG. 4B is a simplified diagram illustrating graphical user interface for adding and/or modifying contacts from network entities.

FIG. 5 is a simplified diagram illustrating a user interface in which a user is able to collaborate and communicate with other users in a procurement network.

FIGS. 6A and 6B are block diagrams illustrating network ontology for a procurement system according to an embodiment of the present invention.

FIG. 7 is a simplified diagram illustrating an HADOOP framework used in an enterprise procurement system according to an embodiment of the present invention.

FIG. 8 is a screen shot of an exemplary search screen according to an embodiment of the present invention.

FIG. 9 is a simplified flow diagram illustrating a method that can be used to assist a user in performing a search at an enterprise procurement system according to an embodiment of the present invention.

FIG. 10 is a simplified block diagram illustrating physical components of a system environment 1000 that may be used in accordance with an embodiment of the present invention.

FIG. 11 is a simplified block diagram illustrating the physical components of a computer system 1100 that may be used in accordance with an embodiment of the present invention.

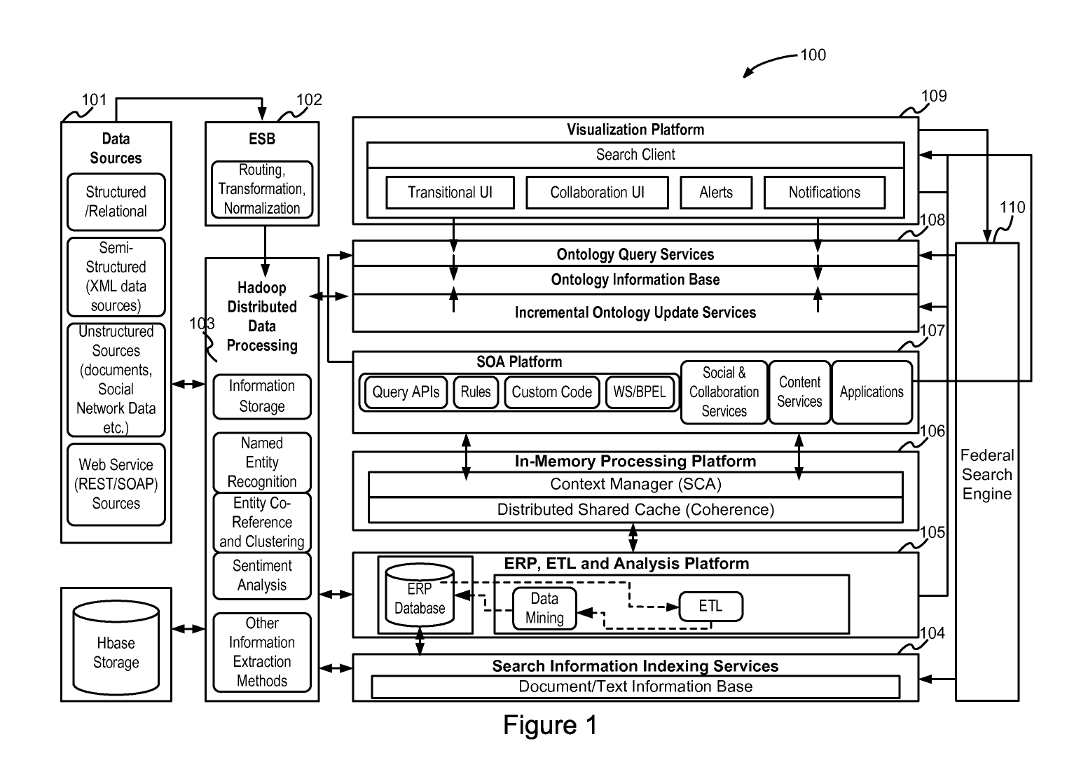

### DETAILED DESCRIPTION OF THE INVENTION

The present invention is directed to solutions for providing enterprise procurement networks. More specifically, various embodiments of the present invention provide techniques for providing a procurement system in which users are able to access a plurality of social network entities, both inside and outside an enterprise network. For example, using the procurement system, users are able to search for products and services from the plurality of social network entities. In various embodiments, the procurement systems according to the present invention are configured to provide security and access policies based on the types of network entities (e.g., enterprise network are deemed more secure and/or reliable than outside social networks). There are other embodiments as well, as will be described below.

As described above, conventional social networks are inadequate for enterprise applications, such as procurement systems. More specifically, conventional techniques do not allow business users to access multiple social networks using a network ontology protected by a system security. Additionally, conventional techniques do not synthesize information from multiple social networks and facilitate procurement processes for users. Therefore, it is to be appreciated that various embodiments provide powerful tools that allow users to obtain procurement information from a plurality of social networks in an efficient manner.

In many ways, the procurement, or buying, process is a social activity. Conventional solutions (e.g., e-commerce web sites) provide a network and data exchange capability for structured information such as purchase orders, invoices, order modifications, and the like. Unfortunately, these solutions are often not enough. Buyers often need more information than what these conventional solutions can provide. Additionally, buyers do not have a procurement platform for secure and flexible sharing of unstructured information such as sharing of ideas through blogs, wiki, and brainstorming, a forum for collaboratively gaining knowledge including Questions and Answers (Q&A), and sharing of other procurement-related knowledge and concerns among users. Instead, these features (if available at all) are provided by separate collaboration systems such as Oracle Beehive™, commercially available from Oracle Corporation, which require configuration to create, administer and build a community; users have to collaborate externally by their own volition. Thus, for example, in a conventional procurement system, creation of a sourcing event does not automatically create a collaboration group which has these capabilities embedded but needs to be manually created, though sourcing is a known collaboration problem with both internal line of business and external supplier members.

Various embodiments provide a community network, which is a platform within the procurement application that creates seeded groups created automatically based on human resource and line of business definitions, as well as groups created once a sourcing event is launched, or once a set of suppliers is stored at a database, such as the Oracle Supplier Network. Using the community network, users can discuss ideas, give recommendations, ask questions and join scheduled chat sessions with domain experts. Moreover, users can view a log of recent group activity, see active and inactive member lists, instantly chat with others etc. These group activities enhance the effectiveness of users in procure-to-pay processes such as self service procurement, strategic sourcing, supplier collaboration, and others.

Users are able to create enterprise networks as well as hybrid networks to enhance collaboration within and outside of the organization. According to one embodiment, a procurement portal allows the user to create a community on his own and add members from another social portal either within his own organization or on the world-wide-web, including external social networks such as LinkedIn™ and Facebook™. For example, the external collaboration helps improve seeded content. To protect enterprise data, additional security constraints are placed, according to access policies, on enterprise procurement applications.

According to one embodiment, each procurement network and/or community has a security and administration console. A network or community administrator can restrict access at a page level, section level, and even at the most granular attribute level. For example, non-members (e.g., users who have no privileges to access network information) can only access publicly-shared content. There are various types of groups and associations within procurement networks. For example, the types of groups include seeded line of buyer (LOB) and department-based groups, groups of third party specialists, service providers, groups related to sourcing events, self service procurement and expenses, supplier contacts, and others.

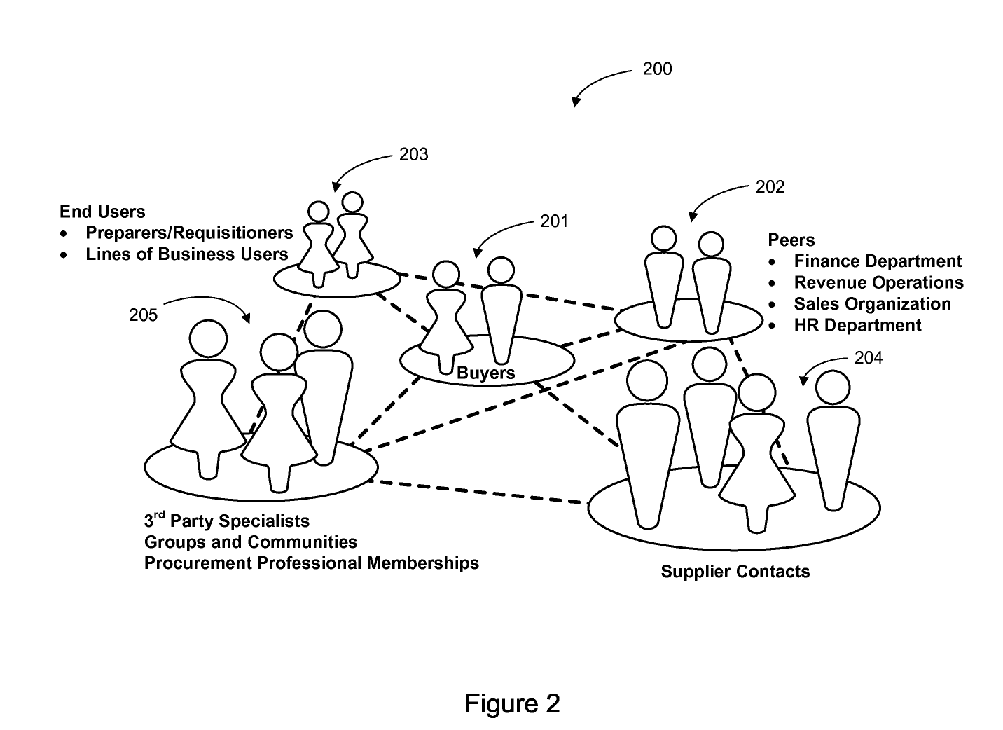

FIG. 2 is a simplified diagram illustrating a hybrid social network according to an embodiment of the present invention. This diagram is merely an example, which should not unduly limit the scope of the claims. One of ordinary skill in the art would recognize many variations, alternatives, and modifications. As shown in FIG. 2, a procurement system 200 includes buyers 201, end users 203, peers 202, third party specialists 205, and supplier contracts 204. As an example, buyers 201 and peers 202 are within an enterprise network, which is secure. Other entities are accessible to users through the enterprise network, but they may not have access privileges to the network itself (and/or may have reduced or modified privileges). For example, when the buyers 201 need to procure one or more products, the buyers 201 are able to access peers 202 within the enterprise network. Peers 202, as shown, might include finance department, revenue operations, sales organizations, HR department, and others. For example, buyers 201 access peers 202 to procure products within the enterprise network, and to obtain relevant information (e.g., budget constraints, buying policies, etc.). Buyers 201 may also obtain information from end users 203.

Buyer 201 may additionally obtain information related to procurement through other entities. For example, third party specialists 205 may be a network community of specialists for providing procurement information and even products. Buyer 201 additionally may communicate with supplier contacts 204 to procure products directly. For example, supplier contacts 204 include online sellers, wholesale stores, and others.

As explained below, the procurement system 200, according to certain embodiments, is able to provide different levels of security and protection of buyers 201 based on the types of parties that buyer 201 is accessing. For example, buyers 201 and peers 202 are both within the enterprise system and thus sensitive information can be shared between buyers 201 and peers 202. One the other hand, when buyers 201 access third party specialists 205, a strict access policy may be imposed by the procurement system 200 to prevent sensitive information from leaking out.

It is to be appreciated that a buyer 201 is able to access, using the procurement system 200, other buyers 201, end users 203, peers 202, third party specialists 205, and supplier contracts 204 at the same time. For example, a buyer 201 may perform a procurement search, in which the procurement system 200 gathers information from end users 203, peers 202, third party specialists 205, and supplier contracts 204. The gathered information is then consolidated, formatted, and filtered to generate a search report for the buyer 201. The buyer 201 is then able to use the search report to procure products and/or services.

As described above, users can be connected to a variety of network entities to obtain information via a procurement system according to various embodiments. The network entities can be both internal (e.g., peer network, internal accounting department, internal information database, etc.) and external (e.g., online store, social networks, blogs, search engines, etc.). Depending on the specific needs, users are able to create a custom network community which includes both internal and external network entities.

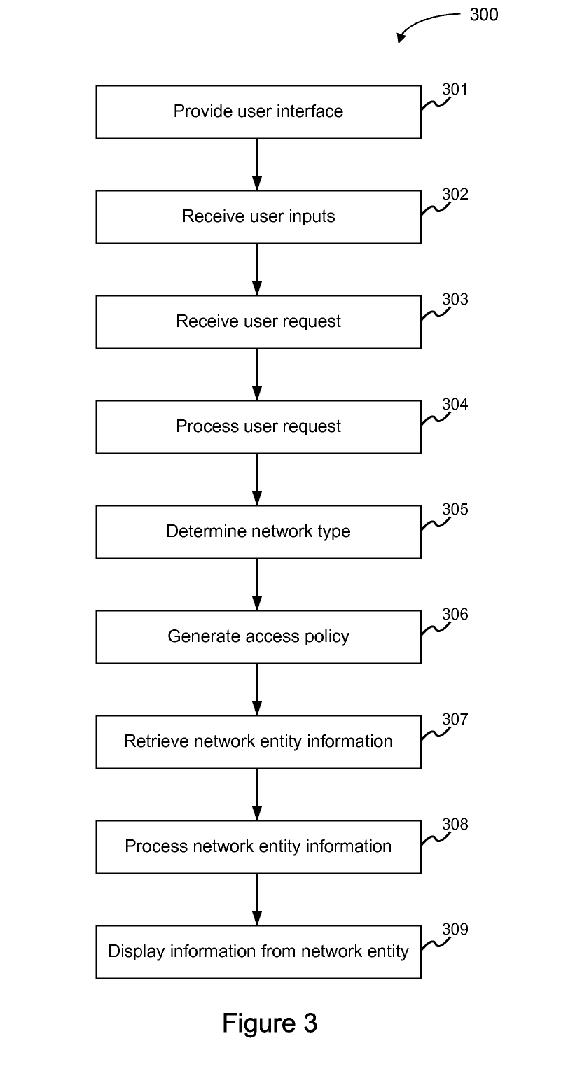

FIG. 3 is a simplified flow diagram illustrating a method that can be used to assist a user in customizing a network community according to an embodiment. This diagram is merely an example, which should not unduly limit the scope of the claims. One of ordinary skill in the art would recognize many variations, alternatives, and modifications. While the techniques and procedures of FIG. 3 are depicted and/or described in a certain order for purposes of illustration, it should be appreciated that certain procedures may be reordered and/or omitted within the scope of various embodiments.

The method 300, in the illustrated embodiment, comprises providing a user interface to allow interaction between a user and the computer system (block 301). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, keyboards (both numeric and alphanumeric), microphones, etc. The procedures undertaken to provide a user interface, therefore, can vary depending on the nature of the implementation; in some cases, providing a user interface can comprise displaying the user interface on a display device; in other cases, however, where the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device.

Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies.

In many cases, providing a user interface will comprise providing one or more display screens, each of which includes one or more user interface elements. As used herein, the term “user interface element” (also described as a “user interface mechanism” or a “user interface device”) means any text, image or device that can be displayed on a display screen for providing information to a user and/or for receiving user input. Some such elements are commonly referred to as “widgets,” and can include, without limitation, text, text boxes, text fields, tables and/or grids, charts, hyperlinks, buttons, lists, combo boxes, checkboxes, radio buttons, and/or the like.

While the exemplary display screens described herein employ specific user interface elements appropriate for the type of information to be conveyed/received by computer system in accordance with the described embodiments, it should be appreciated that the choice of user interface element for a particular purpose is typically implementation-dependent and/or discretionary. Hence, the illustrated user interface elements employed by the display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or for receiving input from a user, the user interface may be the vehicle for the exchange of such input/output. Merely by way of example, in a set of embodiments, the user interface allows the user to input user preferences and select network entities that are to be added to a custom community network.

The method 300 further comprises receiving, at the user interface, inputs for logging on to a user profile (block 302). For example, the user might log onto a network computer within an enterprise network, and the network computer could retrieve user profile information based on the user name and password received from the user. The method 300, then might comprise accessing the user profile, which can be stored at an enterprise network system. In another embodiment, the user profile is stored at a local computer. The user profile includes a plurality of attributes. Among other information, the plurality of attributes includes association between the user and network entities. As explained above, network work entities include enterprise entities and external entities. The network entities include contact information (e.g., supplier contacts, specialist contacts, social network contacts, internal corporate directory, etc.).

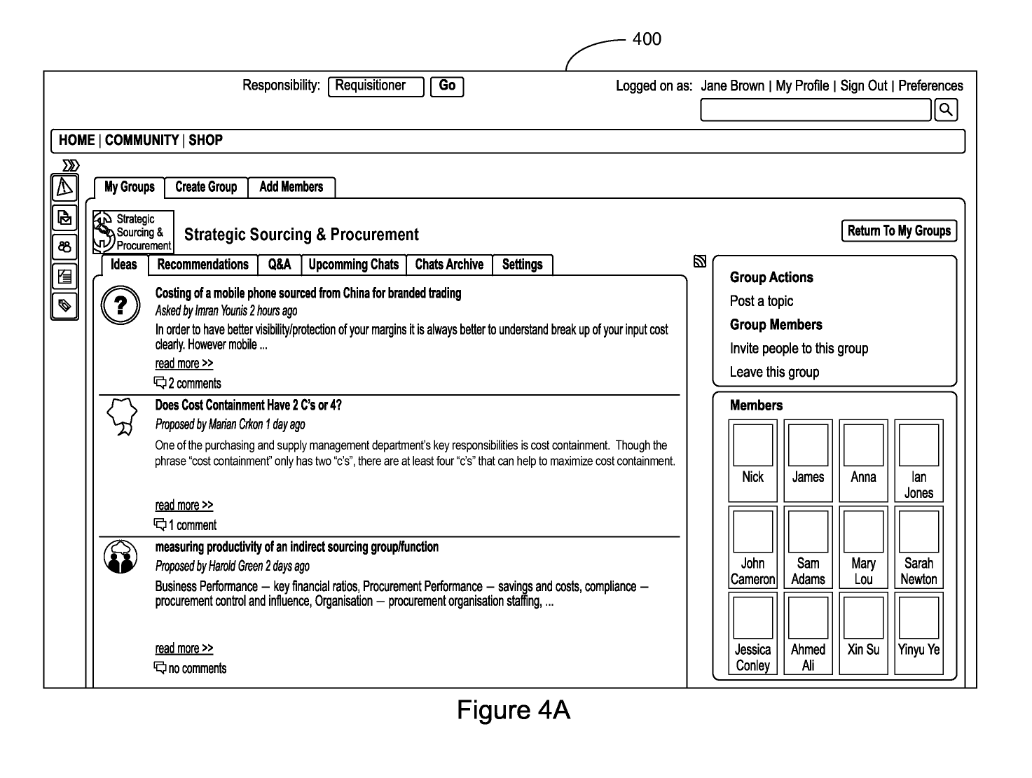

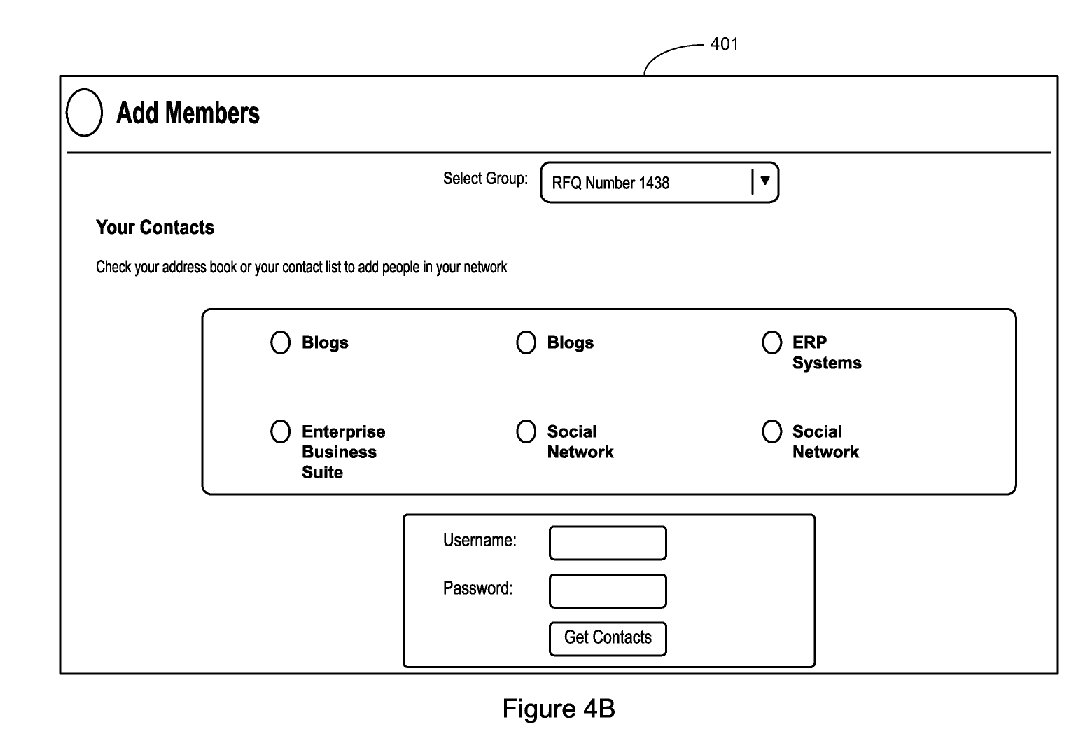

According to one embodiment, a user may create one or more community networks to address various needs. For example, a user profile may be associated with a number of custom community networks, each being a collection of one or more network entities. The custom community network is associated with a set of user preferences to address the needs of users. FIG. 4A is a simplified diagram illustrating a graphical user interface 400 for receiving user inputs for customizing a custom community network according to an embodiment of the present invention. This diagram is merely an example, which should not unduly limit the scope of the claims. One of ordinary skill in the art would recognize many variations, alternatives, and modifications. For example, if the community is about a particular manufacturing supplier, then a custom community network or knowledge base can be useful to all manufacturing suppliers, buyers and consultants. Various network entities and/or individual are brought in together at the custom community network. For example, the screen shown in FIG. 4A is related to strategic sourcing and procurement of mobile phones. In one embodiment, a procurement system according to the present invention automatically generates a member list based on the user settings. In another embodiment, users manually add contacts and/or networks to the custom community network.

Now referring back to FIG. 3, a user request for adding a network entity to the user profile is received (block 303). The network entity is associated with one or more procurement projects. For example, the network entities may be a social network (e.g., Linkedin, Facebook, etc.), shopping website (e.g., buy.com, amazon.com, etc.), Outlook contact groups, and others. FIG. 4B is a simplified diagram illustrating graphical user interface 401 for adding and/or modifying contacts from network entities. This diagram is merely an example, which should not unduly limit the scope of the claims. One of ordinary skill in the art would recognize many variations, alternatives, and modifications. As shown in FIG. 4B, a user may log on, using her user name and password, to networks such as Oracle network and Outlook to retrieve contact information for a custom community network.

Now referring back to FIG. 3, the user request is processed (block 304). Network entities and/or contacts are added to the custom community network. When a user requested network entity is added to the custom community network, the network type for the network entity is determined. For example, the network type (block 305) may be classified as internal, external, secured, unsecured, etc. The method 300 includes generating an access policy for the network entity (block 306). For example, if the network entity that is being added is internal and/or secure, a high level of access is allowed. On the other hand, if the network entity that is being added is external and/or not secure, a low level of access is allowed.

Information from the network entity is retrieved (block 307). As explained above, information may include contact information, procurement information, and others. For example, if the network entity that is being added by the user is a social network, contacts stored at the social network are retrieved. Information from the network entity is processed, at block 308. Depending on the application, information from the network entity may be processed in different ways. For example, information of contacts retrieved from the network entities is formatted and stored. As another example, procurement information retrieved from a supply network entity is analyzed and stored.

Information from the network entity is displayed at the user interface (block 309). For example, information deemed most relevant to a specific procurement project or a community is displayed at user information. The displayed information may include contact information, supply source, and others. In various embodiments, information that is displayed at the user interface is also associated with context sensitive menus. By selecting a contact displayed at the user interface, a user is able to perform specific actions. For example, if the selected contact is a supplier, a context menu becomes available to allow the user to order products directly from the contact. On the other hand, if the selected contact is a consultant, the user can ask questions. In various embodiments, users are able to purchase products using information displayed at the user interface using a “Procure to Pay Process.”

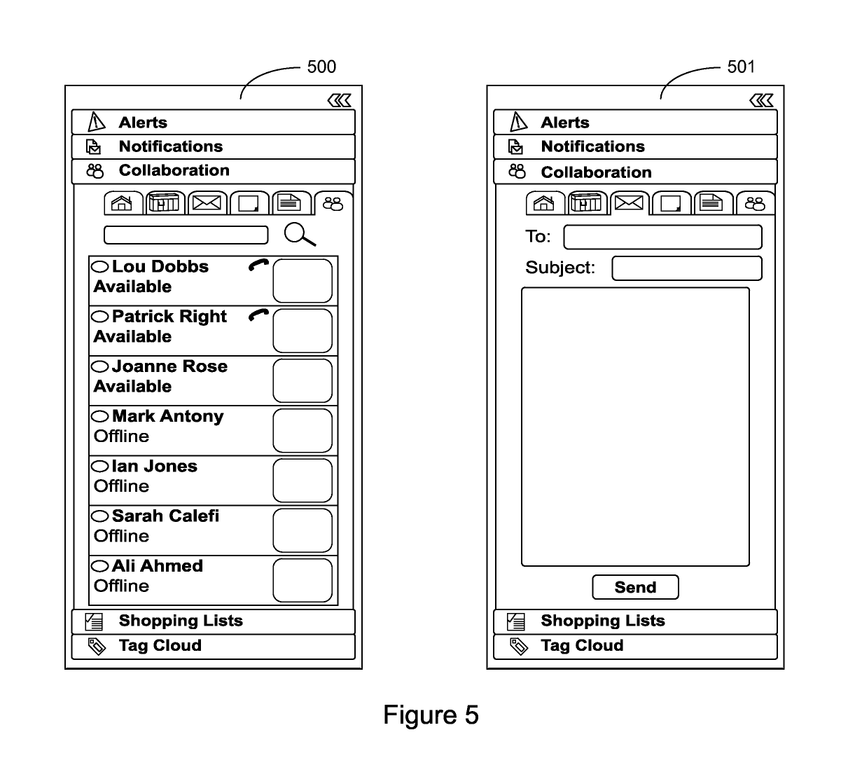

The procurement system according to embodiments of the present invention is not limited to merely displaying information. Among other things, a user is able to interact and collaborate with other users and/or contacts using the procurement system. FIG. 5 is a simplified diagram illustrating a user interface in which a user is able to collaborate and communicate with other users in a procurement network. This diagram is merely an example, which should not unduly limit the scope of the claims. One of ordinary skill in the art would recognize many variations, alternatives, and modifications.

As shown in FIG. 5, a user interface 500 displays alerts, notifications, and contacts, shopping lists, and others. For example, the contacts are from different networks, and based on the types of the contacts, a user can perform different types of collaboration with these contacts. For example, one method of collaboration is to send messages (e.g., email message or instant message) using a message window 501. In addition, users can also connect to one another in real time using instant message, online video conference, voice-over-IP, and others.

It is to be appreciated that the procurement system and the method for customizing a procurement network according to the present invention provides various advantages. Among other things, the procurement system promotes enhanced collaboration among users of the same application that leads to sharing of ideas, reviews, ratings and concerns in the context of the procure-to-pay processes such as sourcing, self service procurement, expenses, supplier communities, etc. In various embodiments, a knowledge base is created over time that is unique and valuable for the domain that the community belongs to. For example, if the community is about a particular manufacturing supplier, then the knowledge base can be useful to all manufacturing suppliers, buyers and consultants.

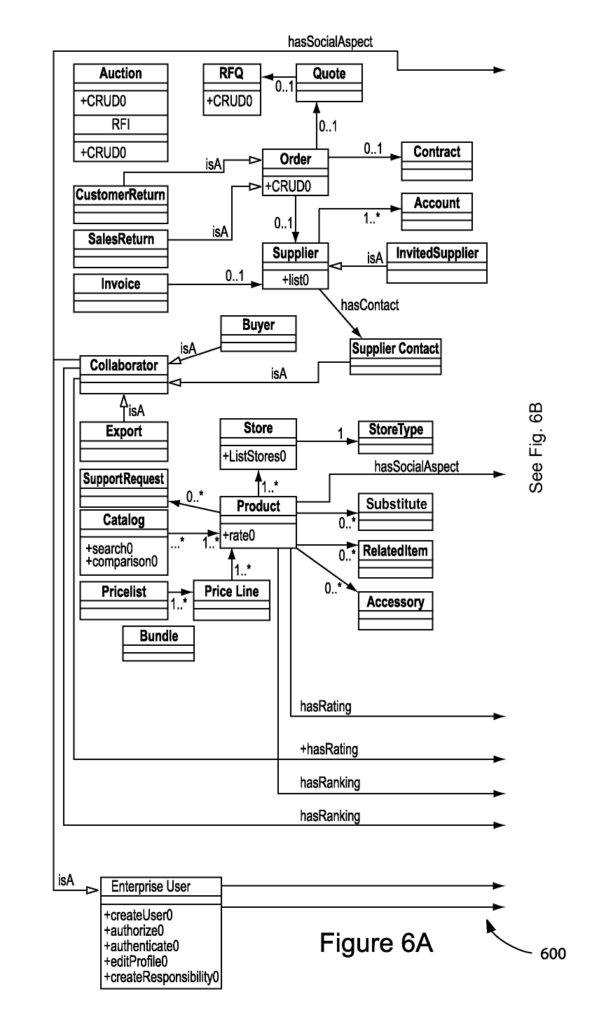

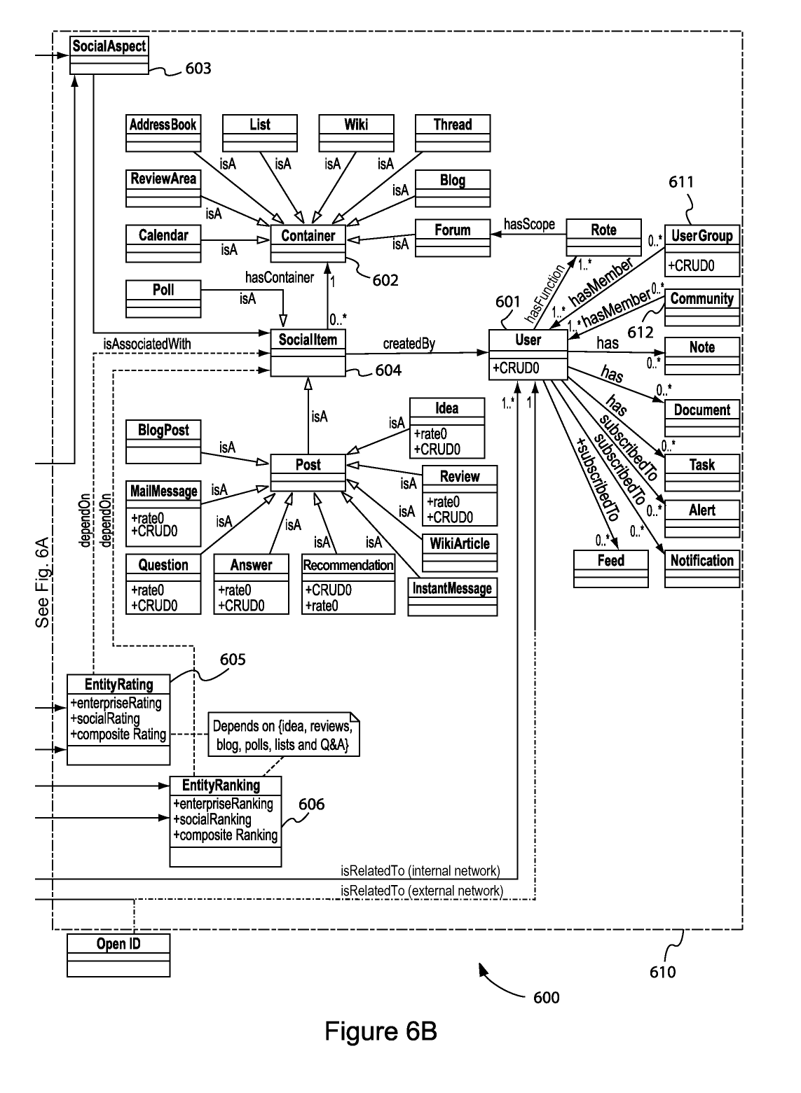

According to an embodiment, a procurement system according to the present invention provides various levels of security for users using a proprietary ontology. FIGS. 6A and 6B are block diagrams illustrating network ontology for a procurement system according to an embodiment of the present invention. This diagram is merely an example, which should not unduly limit the scope of the claims. One of ordinary skill in the art would recognize many variations, alternatives, and modifications. As shown in FIGS. 6A and 6B, a user 601 belongs to an enterprise network 610 and is connected to social networks via a social item module 604.

The social item module 604 is a part of another enterprise network and is configured to process information from both social networks and enterprise applications. The social item module 604 provides user 601 information from various social network entities, such as auction entities, collaborators, suppliers, buyers, stores, and others. Information from various social entities is processed by the social aspect module 603. For example, the social network entities are external to the enterprise network. The social aspect module 603 administrates network security policies over social network entities. For example, information from these social network entities is filtered before being provided to the user, and these social network entities have limited access to the enterprise network.

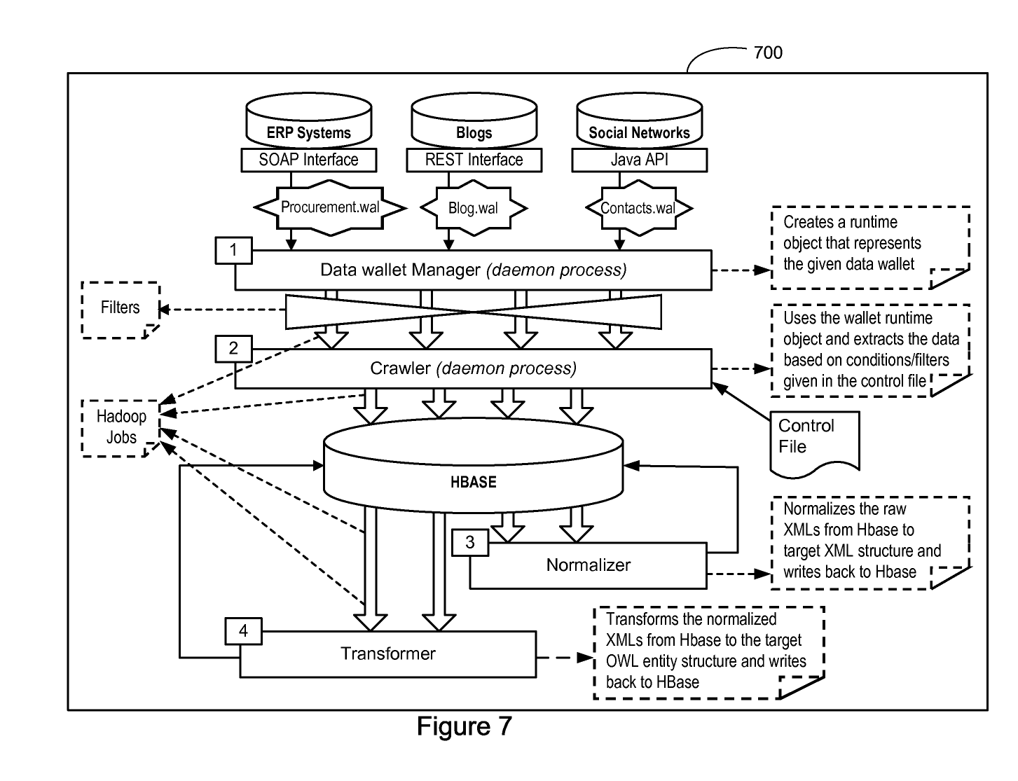

FIG. 7 is a simplified diagram illustrating an HADOOP framework 700 used in an enterprise procurement system according to an embodiment of the present invention. This diagram is merely an example, which should not unduly limit the scope of the claims. One of ordinary skill in the art would recognize many variations, alternatives, and modifications. For example, the social aspect module 603 may be implemented using the HADOOP framework 700 illustrated in FIG. 7.

In a specific embodiment, the enterprise network ontology includes a software as a service (SaaS) platform. Customers, partners, suppliers, outsources, resellers, distributors and other players in procurement and/or sourcing processes can connect across a seamlessly authenticated system. The buyer can now look at a supplier's profile consisting of the supplier's trading partners, reviews by the supplier's trading partners and recommendations by reference customers alongside other operational information. The supplier is also assigned a rating based on feedback and surveys taken by its trading partners. Similarly, the user can add members to a community from within his own organization or from an external network.

Now referring back to FIGS. 6A and 6B, in various embodiments, rating functionalities are provided. For example, the entity rating module 605 provides rating for products, and the user 601 can use the rating information to make procurement decisions. In one embodiment, the rating module 605 computes a supplier's reputation from different sources (e.g., rating by user, blog post, etc.). For example, rating and reputation information may be available at different levels (e.g., weighted rating based the rating contributor). For different users, different ratings can be provided for the same product. For example, a specific model of a suitable word processing professional is rated higher for a word processing department but rated lower for an IS professional. Depending on the applications, there are other types of rating mechanisms as well, such as integrated rating, context specific rating, etc. Various enterprise rating techniques are described in U.S. patent application Ser. No. ______, Attorney Docket No. 021756-098400US, entitled COMMUNITY RATING IN ENTERPRISE APPLICATIONS, filed on ______, which is incorporated by reference herein for all purposes. Similarly, ranking function is provided by the entity ranking module 606.

The user 601 is associated with one or more user profiles and attributes. For example, the user 601 interacts with various networks, both enterprise networks and social networks, through a container module 602. For example, the container module 602 stores information associated with the user 601. As shown, information stored at the container module 602 includes address book entries, wiki entries, threads, blogs, etc. For example, a user 601 may post a blog entry to a social network through the container module 602 and the social item module 604.

Within the enterprise network 610, there are network entities from which users can obtain information and/or interact with other uses. As shown, the user is connected to various entities within the enterprise network 610, which includes user group 611, community 612, and others. As shown, user 601 is directly connected to entities within the enterprise network 610, as these entities are more secure compared to social networks outside the enterprise network 610. For example, entities within the enterprise network may include contacts within the enterprise network, buyers and suppliers having existing contracts with the enterprise, and others.

It is to be appreciated that the ontology, as illustrated in FIGS. 6A and 6B, provides many benefits. Among other things, the enterprise network ontology provides security features that protect the enterprise network and users from potential harm posed by social networks outside the enterprise network. For example, the security features and policies are based on the network ontology. In various embodiments, users and/or network administrators are able to define security features at different layers. In one embodiment, security features are user-based. Depending on the needs of users, attributes of various entities are defined and stored. The social aspect module 603, for example, functions as access control for enterprise applications. From enterprise perspective, security levels are defined at an entity level. For example, at the entity level, information access policies are determined by the location and nature of the entity (e.g., internal v. external, etc.). For example, a user within the enterprise network is able to access internal blogs without restriction, but cannot access blogs from social networks outside the enterprise network.

Using the enterprise network ontology described above, users are able to perform a variety of tasks related to procurement processes. Using various procurement applications provided by the present invention, users are able to learn from each other's mistakes, share ideas and recommendations, ask questions, discover answers, and perform other functions. Users benefit from collaboration with members within the organization and members from partner organizations. In various embodiments, the present invention provides enterprise procurement applications in the form of a web-enabled social platform where users can collaborate with members from within and outside of the enterprise boundary. These procurement applications connect customers, partners, suppliers, outsources, resellers, distributors and all other players in the procurement/sourcing process.

An important aspect of a procurement processes is providing search results for procurement and/or sourcing processes. According to the present invention, an underlying ontology is used to generate relevant search results. For example, if a user searches for a supplier, the results are automatically categorized into events and documents that are related to that supplier. Result categories are hierarchically classified and details can be viewed on selection of a category. Similarly, if the user types in a product name in the search panel, search results are displayed alongside member reviews, ideas, recommendations and answers about that product.

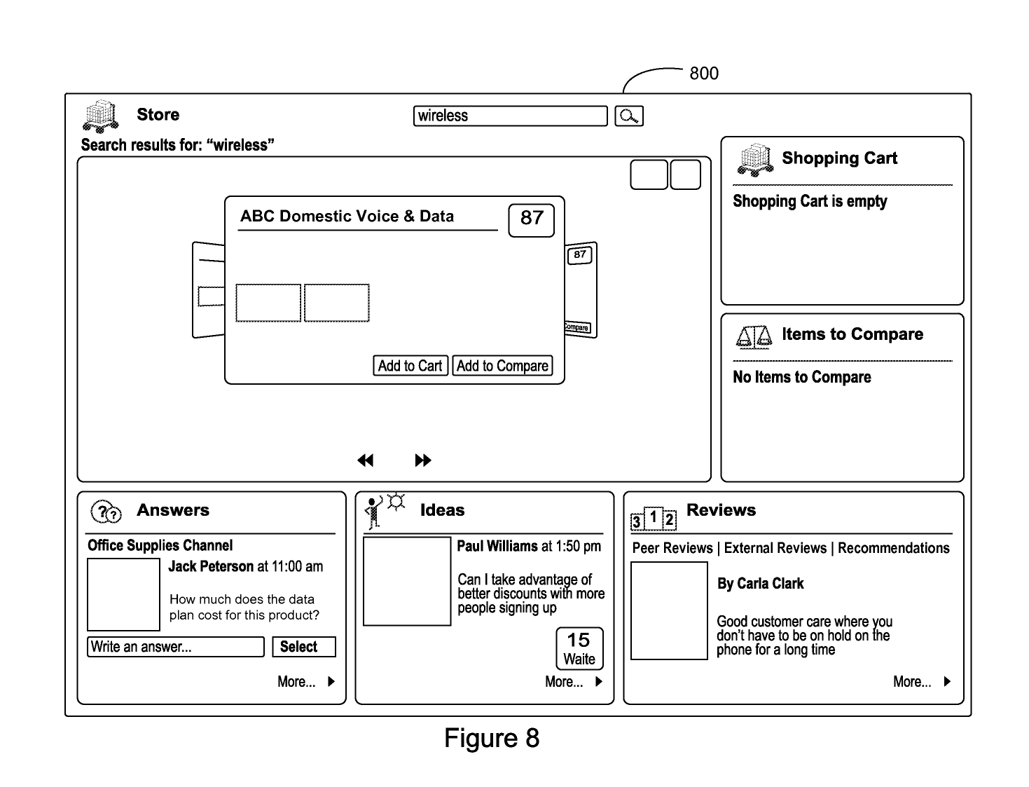

FIG. 8 is screen shot of an exemplary search screen 800 according to an embodiment of the present invention. This diagram is merely an example, which should not unduly limit the scope of the claims. One of ordinary skill in the art would recognize many variations, alternatives, and modifications. For example, search string “wireless” is used. As shown, the search result display includes answers, ideas, reviews, and others. A user is able to order product from the search results display. Rating scores are displayed. For example, rating scores are calculated based on member reviews.

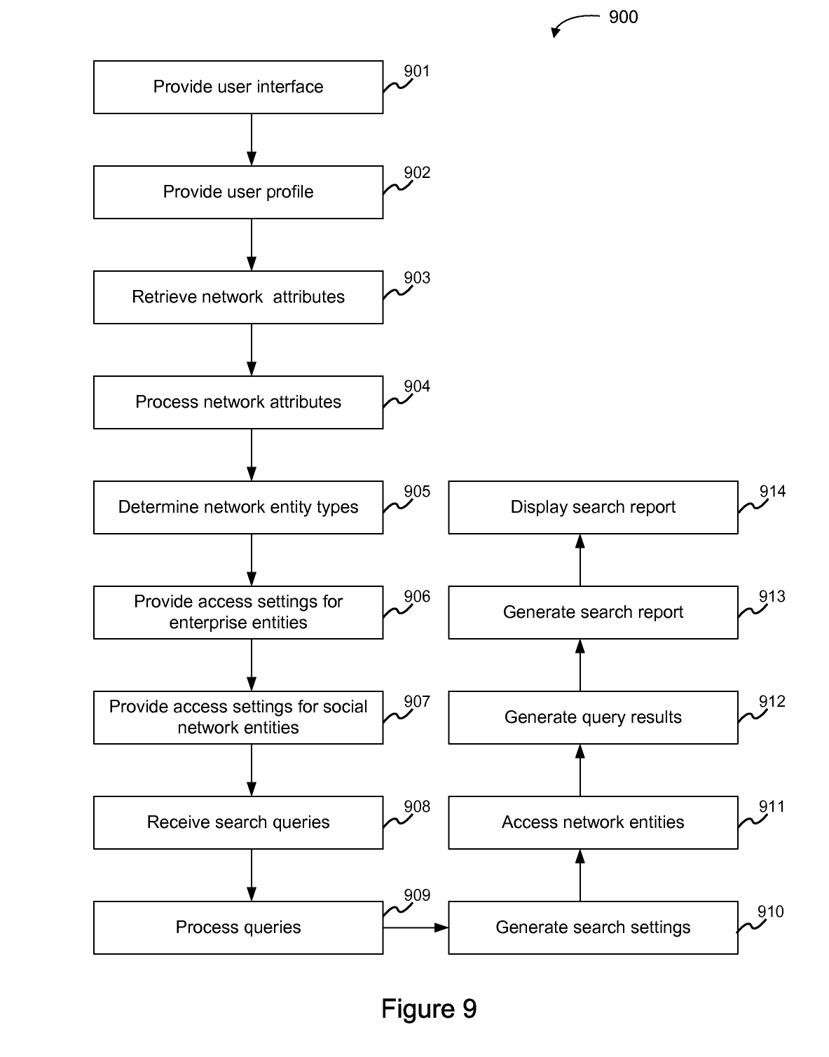

FIG. 9 is a simplified flow diagram illustrating a method that can be used to assist a user in performing a search at an enterprise procurement system according to an embodiment of the present invention. This diagram is merely an example, which should not unduly limit the scope of the claims. One of ordinary skill in the art would recognize many variations, alternatives, and modifications. While the techniques and procedures of FIG. 9 are depicted and/or described in a certain order for purposes of illustration, it should be appreciated that certain procedures may be reordered and/or omitted within the scope of various embodiments.

As shown in FIG. 9, method 900 includes providing, at a computer system, a user interface for receiving input from a user (block 901). For example, the user interface includes a computer display, a keyboard, and a mouse. Method 900 also includes providing a user profile for a user (block 902). The user profile is stored at the enterprise social network system. The user is associated with a plurality of network entities. The network entities include enterprise entities and social network entities. As explained above, network entities can be both inside the enterprise network (e.g., internal servers, blogs, contact lists, etc.) and outside the enterprise network (e.g., search engines, social networks, online stores, etc.). The user profile includes a plurality of user attributes. For example, the user attributes includes user accounting settings and preferences, user contact information, and others. In one embodiment, the user attributes are linked to user data stored at the enterprise network.

Method 900 also includes retrieving entities attributes from each of the network entities (block 903). Entity attributes include, among other things, access information related to the network entities. For example, network attributes for a social network, such as Facebook™, include user settings, security settings, network settings, and others. The entities attributes are processed (block 904), and entity types for network entities are determined (block 905). For example, entity types include social network entity, supplier entity, internal enterprise entity, and others. A first access setting for the enterprise entities is provided (block 906). For example, the first access setting is associated with a first security level. As explained above, access settings and security levels for network entities can depend on various factors, such as the locations and types associated with the network entities, user preferences, predetermined enterprise network policies, and others. A second access setting for the social network entities is provided (block 907). The second access setting is associated with a second security level. For example, since social networks are outside the enterprise network system, the second security level is lower than the first security level.

Method 900 further includes receiving, at the user interface, one or more queries for procurement (block 908). For example, a user may enter search queries using keyboard, mouse, and/or other types of input methods. In various embodiments, a user is able to select one or more search options for the search query. For example, if a user is searching for a particular model of computer, the user is able to specify which network entities are to be searched.

The one or more queries are processed (block 909). A search setting related to the one or more queries is generated (block 910). The search setting is based at least on the user attributes, entity attributes, and the search query itself. For example, if the user attributes indicate that the user is an IS professional, the search setting would indicate that detailed technical information is to be searched from social networks that are relevant to IS professionals.

The network entities are accessed in accordance to the search settings (block 911). A first set of query results from the enterprise entities and a second set of query results from the social network entities are generated (block 912). A search report is generated (block 913). For example, the search report includes information from the first set of query results and the second set of query results. In various embodiments, information on the search report is filtered based on user preferences and network policies. As described above, ratings are provided for the search results. The search report is displayed at the user interface (block 914). As an example, a search report display screen is shown in FIG. 8.

Embodiments of the present invention provide numerous benefits. More specially, users can take advantage of the knowledge base of the entire member community, integrated from both social network entities and enterprise network entities, by seeking suggestions, ideas, reviews, recommendations and answers. Furthermore, users can base their trust of a review or recommendation on member credibility points awarded to the reviewer by other users. Users can view opinions of other members alongside search results, product details, and supplier profile. For example, a buyer can evaluate a supplier based on the supplier's trading partners shown on the supplier's profile page. The buyer can also view supplier ratings given by trading partners of that supplier. As a result, an enterprise or organization can now make informed choices when it comes to procurement and sourcing using enterprise procurement systems provided by the present invention. The eEnterprise saves both time and money because of better decisions. Enterprise users make fewer mistakes resulting in faster turn-around of their requisitions. Enterprise users save time in interacting with others outside of their organization.

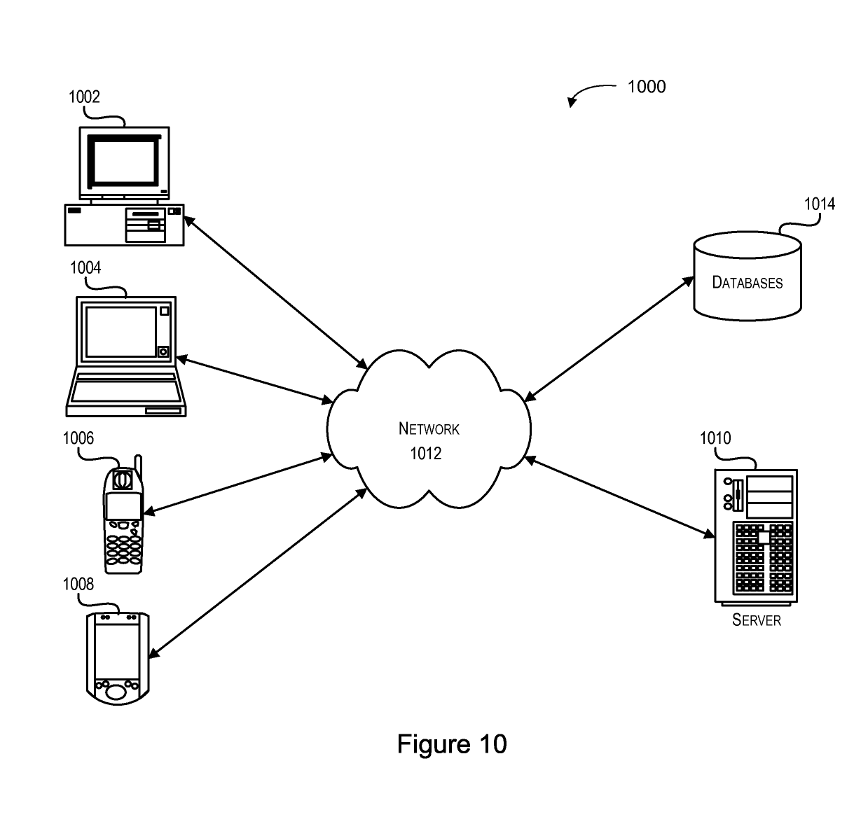

FIG. 10 is a simplified block diagram illustrating physical components of a system environment 1000 that may be used in accordance with an embodiment of the present invention. This diagram is merely an example, which should not unduly limit the scope of the claims. One of ordinary skill in the art would recognize many variations, alternatives, and modifications.

As shown, system environment 1000 includes one or more client computing devices 1002, 1004, 1006, 1008 communicatively coupled with a server computer 1010 via a network 1012. In one set of embodiments, client computing devices 1002, 1004, 1006, 1008 may be configured to run one or more components of a graphical user interface described above. For example, client computing devices allow user to create and customize network communities, enter search queries, view search results, and others.

Client computing devices 1002, 1004, 1006, 1008 may be general purpose personal computers (including, for example, personal computers and/or laptop computers running various versions of Microsoft Windows™ and/or Apple Macintosh™ operating systems), cell phones or PDAs (running software such as Microsoft Windows™ Mobile and being Internet, e-mail, SMS, Blackberry,™ and/or other communication protocol enabled), and/or workstation computers running any of a variety of commercially available UNIX™ or UNIX™-like operating systems (including without limitation the variety of GNU/Linux™ operating systems). Alternatively, client computing devices 1002, 1004, 1006, and 1008 may be any other electronic device capable of communicating over a network (e.g., network 1012 described below) with server computer 1010. Although system environment 1000 is shown with four client computing devices and one server computer, any number of client computing devices and server computers may be supported.

Server computer 1010 may be a general purpose computer, specialized server computer (including, e.g., a LINUX™ server, UNIX™ server, mid-range server, mainframe computer, rack-mounted server, etc.), server farm, server cluster, or any other appropriate arrangement and/or combination. Server computer 1010 may run an operating system including any of those discussed above, as well as any commercially available server operating system. Server computer 1010 may also run any of a variety of server applications and/or mid-tier applications, including web servers, Java virtual machines, application servers, database servers, and the like. In various embodiments, server computer 1010 is adapted to run one or more Web services or software applications described in the foregoing disclosure. For example, server computer 1010 is specifically configured to implemented enterprise procurement systems described above.

As shown, client computing devices 1002, 1004, 1006, 1008 and server computer 1010 are communicatively coupled via network 1012. Network 1012 may be any type of network that can support data communications using any of a variety of commercially available protocols, including without limitation TCP/IP, SNA, IPX, AppleTalk™, and the like. Merely by way of example, network 1012 may be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth™ protocol known in the art, and/or any other wireless protocol); and/or any combination of these and/or other networks. In various embodiments, the client computing devices 1002, 1004, 1006, 1008 and server computer 1010 are able to access the database 1014 through the network 1012. In certain embodiments, the client computing devices 1002, 1004, 1006, 1008 and server computer 1010 each has its own database.

System environment 1000 may also include one or more databases 1014. Database 1014 may correspond to an instance of integration repository as well as any other type of database or data storage component described in this disclosure. Database 1014 may reside in a variety of locations. By way of example, database 1014 may reside on a storage medium local to (and/or resident in) one or more of the computing devices 1002, 1004, 1006, 1008, or server computer 1010. Alternatively, database 1014 may be remote from any or all of the computing devices 1002, 1004, 1006, 1008, or server computer 1010 and/or in communication (e.g., via network 1012) with one or more of these. In one set of embodiments, database 1014 may reside in a storage-area network (SAN) familiar to those skilled in the art. Similarly, any necessary files for performing the functions attributed to the computing devices 1002, 1004, 1006, 1008, or server computer 1010 may be stored locally on the respective computer and/or remotely on database 1014, as appropriate. For example the database 1014 stores user profiles, procurement information, attributes associated with network entities.

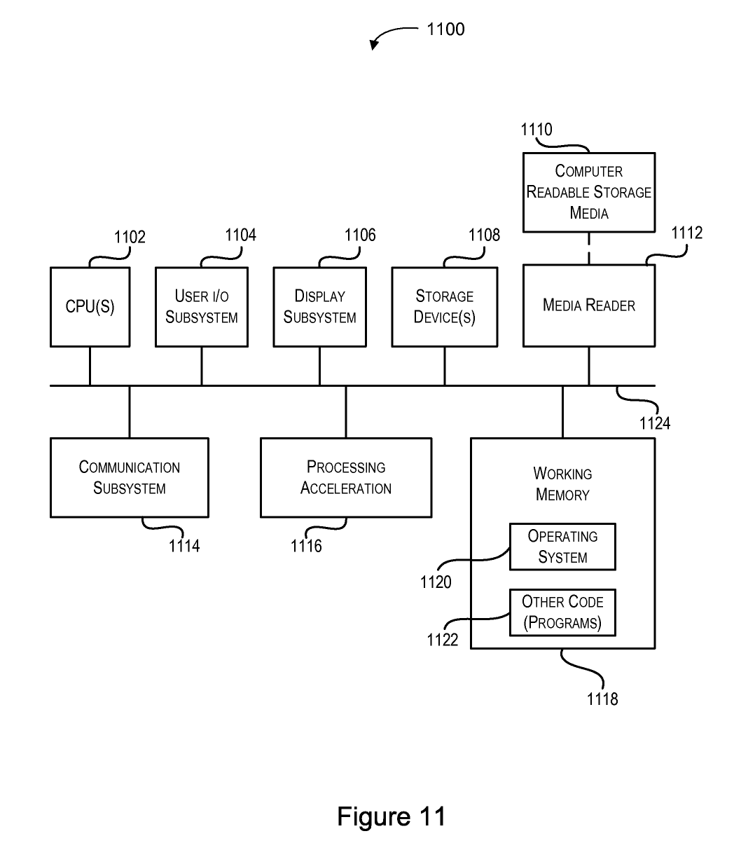

FIG. 11 is a simplified block diagram illustrating the physical components of a computer system 1100 that may be used in accordance with an embodiment of the present invention. This diagram is merely an example, which should not unduly limit the scope of the claims. One of ordinary skill in the art would recognize many variations, alternatives, and modifications.

In various embodiments, computer system 1100 may be used to implement any of the computing devices 1002, 1004, 1006, 1008, or server computer 1010 illustrated in system environment 1000 described above. As shown in FIG. 11, computer system 1100 comprises hardware elements that may be electrically coupled via a bus 1124. The hardware elements may include one or more central processing units (CPUs) 1102, one or more input devices 1104 (e.g., a mouse, a keyboard, etc.), and one or more output devices 1106 (e.g., a display device, a printer, etc.). For example, the input devices 1104 are used to receive user inputs for procurement related search queries. Computer system 1100 may also include one or more storage devices 1108. By way of example, storage devices 1108 may include devices such as disk drives, optical storage devices, and solid-state storage devices such as a random access memory (RAM) and/or a read-only memory (ROM), which can be programmable, flash-updateable and/or the like. In an embodiment, various databases are stored in the storage devices 1108. For example, the central processing unit 1102 is configured to retrieve data from a database and process the data for displaying on a GUI.

Computer system 1100 may additionally include a computer-readable storage media reader 1112, a communications subsystem 1114 (e.g., a modem, a network card (wireless or wired), an infra-red communication device, etc.), and working memory 1118, which may include RAM and ROM devices as described above. In some embodiments, computer system 1100 may also include a processing acceleration unit 1116, which can include a digital signal processor (DSP), a special-purpose processor, and/or the like.

Computer-readable storage media reader 1112 can further be connected to a computer-readable storage medium 1110, together (and, optionally, in combination with storage devices 1108) comprehensively representing remote, local, fixed, and/or removable storage devices plus storage media for temporarily and/or more permanently containing computer-readable information. Communications system 1114 may permit data to be exchanged with network 1012 of FIG. 10 and/or any other computer described above with respect to system environment 1000.

Computer system 1100 may also comprise software elements, shown as being currently located within working memory 1118, including an operating system 1120 and/or other code 1122, such as an application program (which may be a client application, Web browser, mid-tier application, RDBMS, etc.). In a particular embodiment, working memory 1118 may include executable code and associated data structures for one or more of the design-time or runtime components/services illustrated in FIGS. 3 and 6. It should be appreciated that alternative embodiments of computer system 1100 may have numerous variations from that described above. For example, customized hardware might also be used and/or particular elements might be implemented in hardware, software (including portable software, such as applets), or both. Further, connection to other computing devices such as network input/output devices may be employed. In various embodiments, the behavior of the view functions described throughout the present application is implemented as software elements of the computer system 1100.

In one set of embodiments, the techniques described herein may be implemented as program code executable by a computer system (such as a computer system 1100) and may be stored on machine-readable media. Machine-readable media may include any appropriate media known or used in the art, including storage media and communication media, such as (but not limited to) volatile and non-volatile, removable and non-removable media implemented in any method or technology for storage and/or transmission of information such as machine-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store or transmit the desired information and which can be accessed by a computer.

Although specific embodiments of the present invention have been described, various modifications, alterations, alternative constructions, and equivalents are within the scope of the invention. Further, while embodiments of the present invention have been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

1. A computer system for retrieving and providing procurement information from a plurality of social network entities associated with an enterprise social network, comprising:
one or more processors; and
a memory communicatively coupled with and readable by the one or more processors and having stored therein an enterprise application which, when executed by the one or more processors, cause the one or more processors to:
provide a user interface for receiving input from a user;
provide a user profile for a user, the user profile being stored at the enterprise social network, the user being associated with a plurality of network entities, the user profile including a first plurality of user attributes, the network entities including enterprise entities and social network entities;
retrieve entity attributes from each of the network entities;
process entity attributes;
determine entity types for network entities;
provide a first access setting for the enterprise entities, the first access setting being associated with a first security level;
provide a second access setting for the social network entities, the second access setting being associated with a second security level;
receive, at the user interface, one or more queries for procurement;
process the one or more queries;
generate a search setting related to the one or more queries, the search settings being based at least on the user attributes, entity attributes, and the one or more queries;
access the network entities in accordance to the search settings;
generate a first set of query results from the enterprise entities;
generate a second set of query results from the social network entities;
generate a search report, the search report including information from the first set of query results and the second set of query results; and
display, at the user interface, the search report.

2. The system of claim 1, wherein the enterprise application when further executed by the one or more processors, causes the one or more processors to:
filter the first and second sets of query results based on the user profile.

3. The system of claim 1, wherein the enterprise application when further executed by the one or more processors, causes the one or more processors to:
receive user inputs for adding a set of one or more social network entities; and
store the set of one or more social network entities at a database.

4. The system of claim 1, wherein the enterprise application when further executed by the one or more processors, causes the one or more processors to:
generate a list of contacts from the network entities;
determine access policy for each of the contacts; and
display the list of contacts.

5. The system of claim 1, wherein the enterprise application when further executed by the one or more processors, causes the one or more processors to:
calculate ratings for the search report, the ratings being weighted based at least on the user profile.

6. A computer-readable storage medium having stored thereon a set of instructions for providing a procurement system which, when executed by a computer, causes the computer to:
provide a user interface for receiving input from a user;
receive, at the user interface, inputs for logging on to a user profile;
access the user profile, the user profile being stored at an enterprise network system, the user profile including a plurality of attributes, the plurality of attributes including association between the user and network entities, the network entities including enterprise entities and external entities, the network entities including a first plurality of contacts;
receive a user request for adding a first network entity to the user profile, the first network entity being associated with one or more procurement projects;
process the user request;
determine a network type for the first network entity;
generate a first access policy for the first network entity;
retrieve information from the first network entity, the information associated with a second plurality of contacts stored at the first network entity;
process the information associated with the second plurality of contacts; and
display first and second pluralities of contacts at the user interface.

7. The computer-readable storage medium of claim 6, wherein the set of instructions when further executed by the computer, causes the computer to:
determine contact types for the first and second plurality of contacts, the contact types including at least supplier and user; and
generate context menus for each of the contacts based on the contact types.

8. The computer-readable storage medium of claim 6, wherein the set of instructions when further executed by the computer, causes the computer to:
receive a set of logon information associated with the first network entity;
store the set of logon information; and
access the first network entity using the logon information in accordance with the first access policy.

9. The computer-readable storage medium of claim 6, wherein the set of instructions when further executed by the computer, causes the computer to:
receive user inputs, at the user interface, for creating a custom network entity.

10. The computer-readable storage medium of claim 9, wherein the set of instructions when further executed by the computer, causes the computer to:
provide, at the user interface, options for customizing the custom network entity.

11. The computer-readable storage medium of claim 9, wherein the set of instructions when further executed by the computer, causes the computer to:
automatically generate a third plurality of contacts for the custom network entity.

12. The computer-readable storage medium of claim 6, wherein the set of instructions when further executed by the computer, causes the computer to implement a network interface for communicating with the external entities.

13. The computer-readable storage medium of claim 6, wherein the set of instructions when further executed by the computer, causes the computer to:
display, at the user interface, ratings associated with the contacts.

14. A method for providing a procurement system, the method comprising:
providing, at a computer system, a user interface for receiving input from a user;
providing a user profile for a user, the user profile being stored at the enterprise social network system, the user being associated with a plurality of network entities, the user profile including a first plurality of user attributes, the network entities including enterprise entities and social network entities;
retrieving entity attributes from each of the network entities;
processing entity attributes;
providing a first access setting for the enterprise entities, the first access setting being associated with a first security level;
providing a second access setting for the social network entities, the second access setting being associated with a second security level;
receiving, at the user interface, one or more queries for procurement;
processing the one or more queries;
generating a search setting related to the one or more queries, the search settings being based at least on the user attributes, entity attributes, and the one or more queries;
searching the network entities in accordance to the search settings;
retrieving a first set of query results from the enterprise entities;
retrieving a second set of query results from the social network entities;
filtering the first and second sets of query results based at least on the user profile;
generating a search report, the search report including information from the first set of query results and the second set of query results; and
displaying, at the user interface, the search report.

15. The method of claim 14 further comprising synthesizing the first and second sets of queries.

16. The method of claim 14 further comprising receiving user inputs, at the user interface, for creating a custom network entity.

17. The method of claim 16 further comprising providing, at the user interface, options for customizing the custom network entity.

18. The method of claim 14 further comprising automatically generating a third plurality of contacts for the custom network entity.

19. The method of claim 14 further comprising a network interface for communicating with the external entities.

20. The method of claim 14 further comprising displaying, at the user interface, ratings associated with the contacts.
